(19) United States
(12) Patent Application Publication
(10) Pub. No.: US 2026/0075344 A1
(43) Pub. Date: Mar. 12, 2026

(54) TRANSDUCER ASSEMBLY, HEADPHONE, AND HEADPHONE SYSTEM

(71) Applicant: SUUNTO SPORTS TECHNOLOGY (DONGGUAN) CO., LTD., Dongguan (CN)

(72) Inventors: Junlin CHEN, Dongguan (CN); Zhonglin ZHANG, Dongguan (CN); Biao HU, Dongguan (CN)

(21) Appl. No.: 19/394,922

(22) Filed: Nov. 20, 2025

Related U.S. Application Data
(63) Continuation of application No. PCT/CN2024/116081, filed on Aug. 30, 2024.

(51) Int. Cl. H04R 1/02; H04R 1/10

(52) U.S. Cl. CPC H04R 1/025; H04R 1/1008; H04R 1/1025; H04R 1/1041; H04R 1/105; H04R 2201/02

(57) ABSTRACT

A transducer assembly includes a transducer box, a deformable waterproof member, and a button. The transducer box has a mounting cavity and a mounting area that are in communication with each other. The waterproof member is located in the mounting area and integrally formed with the transducer box through two-color injection molding. The waterproof member is configured to cover an opening of the mounting area facing towards an interior of the transducer box. The button is mounted in the mounting area and connected to the waterproof member.

### CROSS-REFERENCE TO RELATED APPLICATION

This application is a continuation of International Application No. PCT/CN2024/116081, filed on August 30, 2024, the entire contents of which are incorporated herein by reference.

### FIELD

The present disclosure relates to the field of headphone technologies, and more particularly, to a transducer assembly, a headphone, and a headphone system.

### BACKGROUND

A transducer assembly of a headphone is configured to allow a user to hear sounds. A deformable waterproof member is usually disposed between a transducer box and a button of the transducer assembly. On the one hand, the waterproof member can prevent external liquid from entering the transducer box. On the other hand, when the user presses the button, the waterproof member can be deformed to trigger a switch at a circuit board in the transducer box, realizing functions such as answering a call or adjusting the volume of the headphone.

### SUMMARY

A transducer assembly, a headphone, and a headphone system are provided in embodiments of the present disclosure.

The transducer assembly according to the embodiments of the present disclosure includes a transducer box, a deformable waterproof member, and a button. The transducer box has a mounting cavity. The transducer box has a mounting area in communication with the mounting cavity. The waterproof member is located in the mounting area and integrally formed with the transducer box through two-color injection molding. The waterproof member is configured to cover an opening of the mounting area, the opening facing towards an interior of the transducer box. The button is mounted in the mounting area and connected to the waterproof member. The button is exposed from the mounting area to an exterior of the transducer box.

In some embodiments, the mounting area has a holding part extending from a side wall of the transducer box and defining a mounting hole. The waterproof member and the holding part are integrally formed through two-color injection molding.

In some embodiments, the waterproof member has a lower hardness than the transducer box.

In some embodiments, the waterproof member is made of soft plastic, and the transducer box is made of hard plastic.

In some embodiments, the waterproof member includes a first waterproof portion located in the mounting hole and a second waterproof portion surrounding and connected to a periphery of the first waterproof portion. The second waterproof portion is embedded in and connected to the holding part and connected to an inner side wall of the transducer box. When a force from the button is applied to the first waterproof portion, the first waterproof portion is deformed under the force, and the second waterproof portion remains connected to the holding part and the inner side wall of the transducer box.

In some embodiments, the holding part includes a first protrusion and a second protrusion that are arranged in a stepped configuration in a thickness direction of the button. The first protrusion is closer to the exterior of the transducer box than the second protrusion.

In some embodiments, the second protrusion has an injection hole penetrating the second protrusion. The second waterproof portion is at least partially located in the injection hole to be embedded in and connected to the second protrusion.

In some embodiments, the holding part has a supporting portion at a side of the holding part, the side facing towards the transducer box. The supporting portion is disposed to surround the mounting hole and protrudes towards the interior of the transducer box relative to the second protrusion.

In some embodiments, the first protrusion is provided with a lug at a periphery of the first protrusion, the periphery facing towards the second protrusion. The first waterproof portion is formed with a recess at an outer side of the first waterproof portion. The recess is engaged with the lug.

In some embodiments, the transducer box has a groove at the inner side wall of the transducer box. The second waterproof portion is at least partially located in the groove. A concave-convex fit is formed between the second waterproof portion and the inner side wall of the transducer box.

In some embodiments, in a thickness direction of the waterproof member, the first waterproof portion has a first side and a second side that are opposite to each other. The first side of the first waterproof portion is closer to the exterior of the transducer box than the second side of the first waterproof portion. The first side of the first waterproof portion includes a mounting post having an insertion hole. In the thickness direction of the waterproof member, the button has a first side and a second side that are opposite to each other. The first side of the button is closer to the exterior of the transducer box than the second side of the button. The second side of the button includes a connection post that extends into the insertion hole of the mounting post.

In some embodiments, a center of the insertion hole is located on a length mid-plane and a width mid-plane of the first waterproof portion.

In some embodiments, a plurality of mounting posts are provided, and each of the plurality of mounting posts has the insertion hole. A plurality of connection posts are provided and inserted in a plurality of insertion holes, respectively.

In some embodiments, the plurality of mounting posts are arranged in sequence in a length direction or a width direction of the waterproof member. Adjacent mounting posts of the plurality of mounting posts share a side wall. The side wall of at least one of the plurality of mounting posts has a notch extending through an inner side and an outer side of the side wall and in communication with the insertion hole.

In some embodiments, each of the plurality of mounting posts has a notch. An extension direction of a plurality of notches is consistent with the length direction or the width direction of the waterproof member.

In some embodiments, the button is in clearance fit with the mounting area.

In some embodiments, the transducer assembly further includes a circuit board and a switch that are accommodated in the transducer box. The switch is mounted on the circuit board and corresponds to the waterproof member. When the button is pressed to drive the waterproof member to deform, the waterproof member abuts against the switch, to trigger the switch.

In some embodiments, the first waterproof portion of the waterproof member has a triggering protrusion at a second side of the first waterproof portion. The triggering protrusion corresponds to the switch in a thickness direction of the waterproof member. The triggering protrusion is configured to abut against the switch.

The headphone according to the embodiments of the present disclosure includes the transducer assembly according to the above-described embodiments.

In some embodiments, the headphone includes a bone conduction headphone and an air conduction headphone.

The headphone system according to the embodiments of the present disclosure includes the headphone according to the above-described embodiments and a charging case configured to charge the headphone.

Additional aspects and advantages of the present disclosure will be provided in part in the following description, or will become apparent in part from the following description, or can be learned from practicing of the present disclosure.

### BRIEF DESCRIPTION OF THEDRAWINGS

The above and/or additional aspects and advantages of the present disclosure will become more apparent and more understandable from the following description of embodiments taken in conjunction with the accompanying drawings.

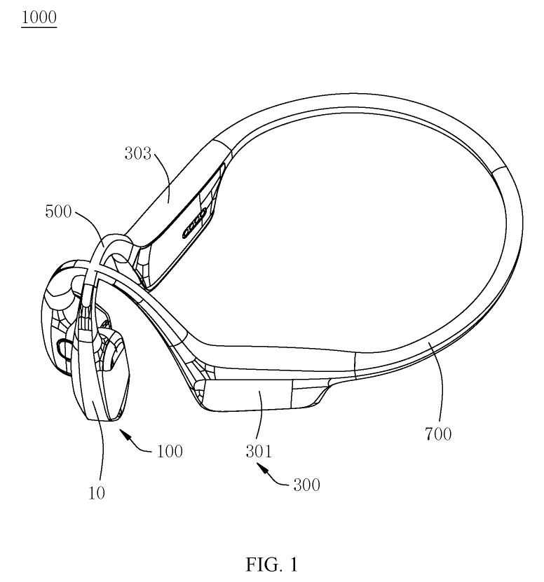

FIG. 1 is a schematic perspective view of a headphone according to some embodiments of the present disclosure.

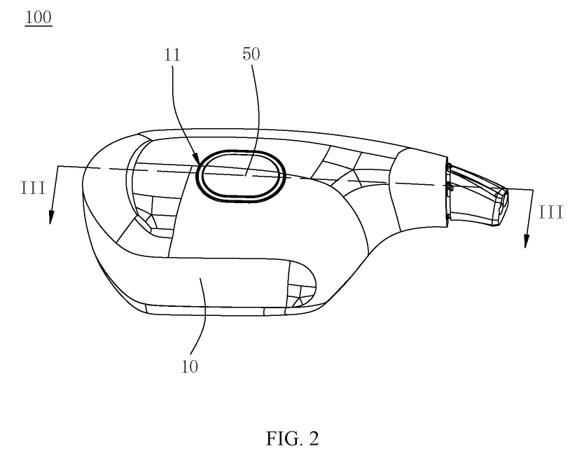

FIG. 2 is a schematic perspective view of a function box assembly in the headphone of FIG. 1.

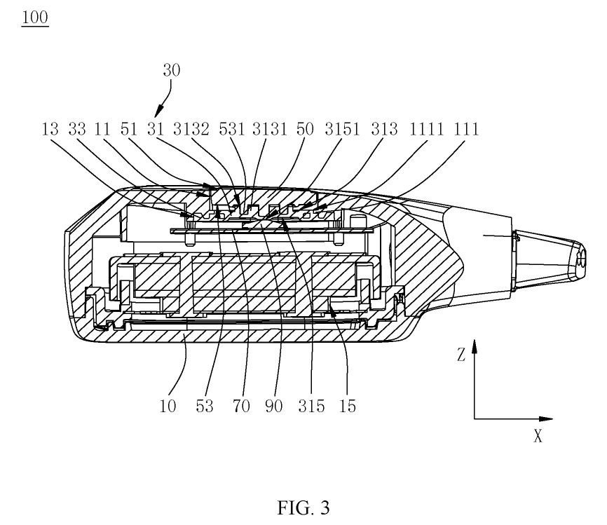

FIG. 3 is a schematic cross-sectional view of a transducer assembly in FIG. 2 taken along line III-III.

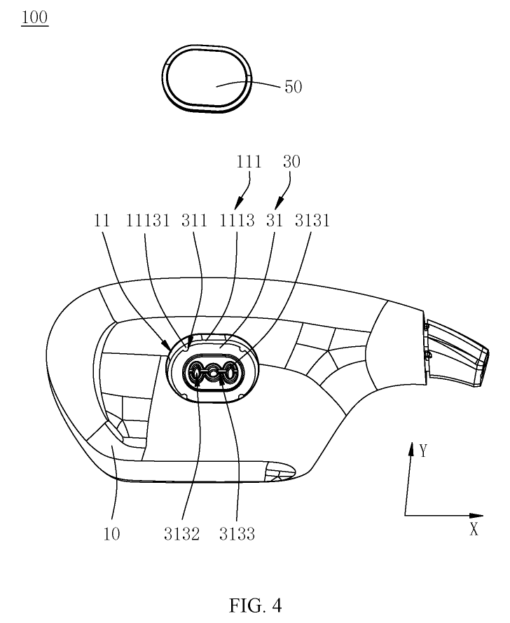

FIG. 4 is a schematic perspective exploded view of a partial structure of a transducer assembly in FIG. 2.

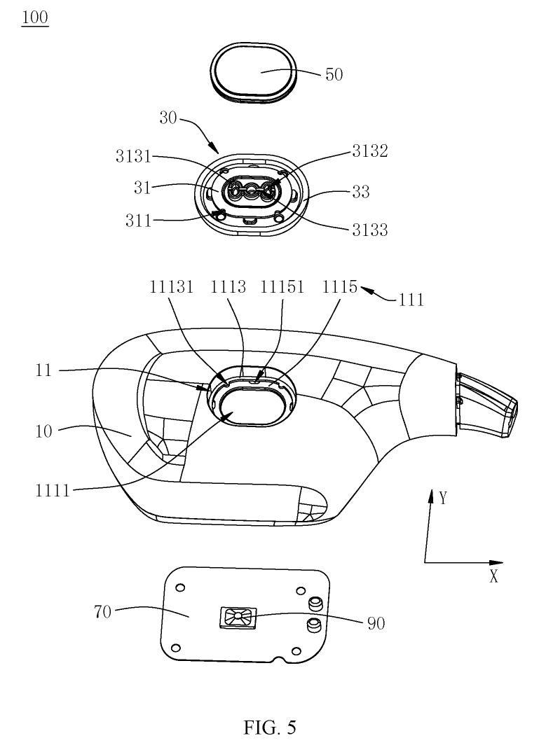

FIG. 5 is a schematic perspective exploded view of a transducer assembly in FIG. 2.

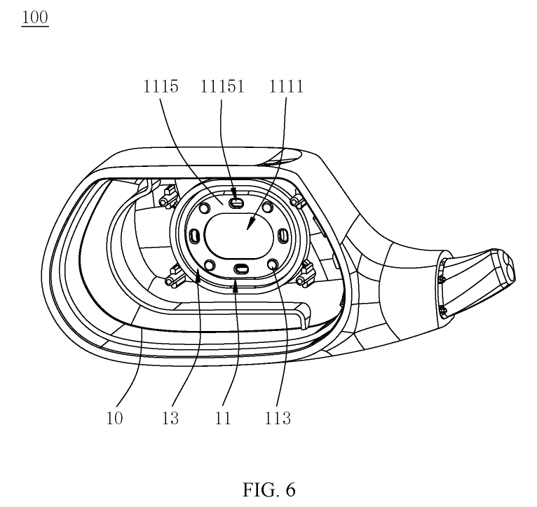

FIG. 6 is a schematic perspective view of a partial structure of a transducer assembly in FIG. 2.

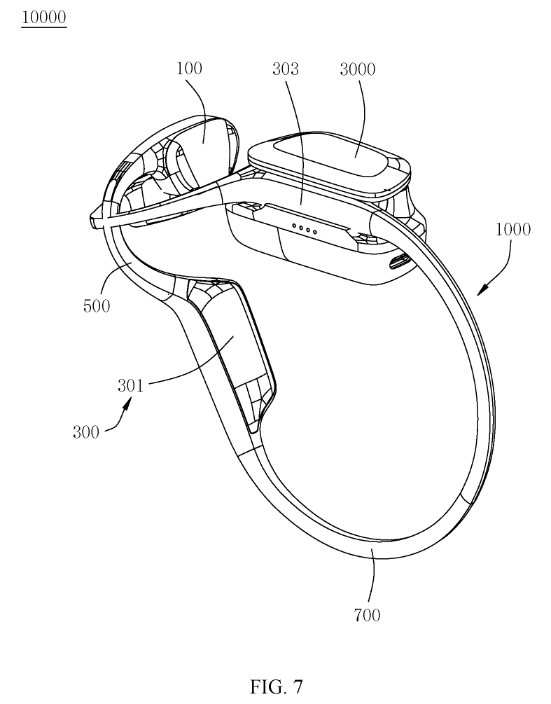

FIG. 7 is a schematic perspective view of a headphone system according to some embodiments of the present disclosure.

Description of reference symbols of main components:

10000, headphone system; 1000, headphone; 3000, charging case; 300, function box assembly; 301, control box assembly; 303, battery box assembly; 500, ear hook; 700, rear hook; 100, transducer assembly; 10, transducer box; 11, mounting area; 111, holding part; 1111, mounting hole; 1113, first protrusion; 11131, lug; 1115, second protrusion; 11151, injection hole; 113, supporting portion; 13, groove; 15, mounting cavity; 30, waterproof member; 31, first waterproof portion; 311, recess; 313, first side of first waterproof portion; 3131, mounting post; 3132, insertion hole; 3133, notch; 315, second side of first waterproof portion; 3151, triggering protrusion; 33, second waterproof portion; 50, button; 51, first side of button; 53, second side of button; 531, connection post; 70, circuit board; 90, switch.

### DETAILED DESCRIPTION

To make the above-mentioned objects, features, and advantages of the present disclosure more obvious and comprehensive, a detailed description of specific embodiments of the present disclosure will be given below in conjunction with the accompanying drawings. In the following description, many specific details are provided to facilitate full understanding of the present disclosure. However, the present disclosure can be implemented in many other ways than those described herein, and similar improvements can be made by those skilled in the art without contradicting the intent of the present disclosure. Therefore, the present disclosure is not limited by specific embodiments disclosed below.

In the description of the present disclosure, it should be understood that the orientation or the position indicated by terms such as “center”, “longitudinal”, “transverse”, “length”, “width”, “thickness”, “over”, “below”, “front”, “rear”, “left”, “right”, “vertical”, “horizontal”, “top”, “bottom”, “inner”, “outer”, “clockwise”, “anti-clockwise”, “axial”, “radial”, and “circumferential” should be construed to refer to the orientation or the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure.

In addition, terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “plurality” means at least two, such as two and three, unless otherwise specifically defined.

In the present disclosure, unless otherwise clearly specified and limited, terms such as “install”, “connect”, “connect to”, “fix”, and the like should be understood in a broad sense. For example, it may be a fixed connection or a detachable connection or connection as one piece; mechanical connection or electrical connection; direct connection or indirect connection through an intermediate; internal communication of two components or the interaction relationship between two components, unless otherwise specifically defined. For those of ordinary skill in the art, the specific meaning of the above-mentioned terms in the present disclosure can be understood according to specific circumstances.

In the present disclosure, unless specified or limited otherwise, the first characteristic “on” or “under” the second characteristic may mean that the first characteristic and the second characteristic are in direct contact with each other or in indirect contact via media. And, the first characteristic “on”, “above”, “over” the second characteristic may mean that the first characteristic is right over the second characteristic or is diagonal above the second characteristic, or just mean that the horizontal height of the first characteristic is higher than the horizontal height of the second characteristic. The first characteristic “below” or “under” the second characteristic may mean that the first characteristic is right over the second characteristic or is diagonal under the second characteristic, or just mean that the horizontal height of the first characteristic is lower than the horizontal height of the second characteristic.

It should be noted that when an element is described as being “fixed to” or “arranged on” another element, it may be directly on the other element or an intermediate element may exit. When an element is interpreted as being “connected” to another element, it may be directly connected to the other element or an intermediate element may exit simultaneously. As used herein, the terms “vertical”, “horizontal”, “over”, “below”, “left”, and “right” and similar expressions are used for illustrative purposes only and are not meant to be the only means of implementation.

A transducer assembly of a headphone is configured to allow a user to hear sounds. A deformable waterproof member is usually disposed between a transducer box and a button of the transducer assembly. On the one hand, the waterproof member can prevent external liquid from entering the transducer box. On the other hand, when the user presses the button, the waterproof member can be deformed to trigger a switch at a circuit board in the transducer box, realizing functions such as answering a call or adjusting volume of the headphone. However, when the user is swimming or diving, due to excessive water pressure, the button is subjected to pressure applied by the water flow. The button transfers the pressure to the waterproof member, which deforms to a certain extent and triggers the switch on the circuit board. Therefore, the switch on the circuit board is at risk of being accidentally triggered, affecting actual use of the headphone. To solve this problem, a transducer assembly 100 (as illustrated in FIG. 2), a headphone 1000 (as illustrated in FIG. 1), and a headphone system 10000 (as illustrated in FIG. 7) are provided according to embodiments of the present disclosure.

As illustrated in FIG. 1 and FIG. 2, the headphone 1000 according to the embodiments of the present disclosure includes the transducer assembly 100. In some embodiments, the headphone 1000 includes a bone conduction headphone 1000 and an air conduction headphone 1000.

The bone conduction headphone 1000 uses human bones as a medium and converts sound into mechanical vibrations. The mechanical vibrations transmit sound waves through the human bones, to allow the user to hear the sound. Since the sound of the bone conduction headphone 1000 acts on the bones, long-term use does not significantly affect the tympanic membrane of the user’s ears, which can effectively protect the user’s hearing. The air conduction headphone 1000 transmits sound through air vibrations and has better sound quality and penetration. The headphone 1000 of the present disclosure is described by taking the bone conduction headphone 1000 as an example.

The transducer assembly 100 of the present disclosure is configured to be in close contact with human skin. When the headphone 1000 is in use, the transducer assembly 1000 can generate vibrations that are transmitted through the human bones, allowing the user to hear the sound. The headphone 1000 of the present disclosure further includes a function box assembly 300 electrically connected to the transducer assembly 100. The function box assembly 300 may include a battery box assembly 303 and/or a control box assembly 301. The control box assembly 301 may be configured to control power-on and power-off of the headphone 1000 and adjust volume of the headphone 1000. The battery box assembly 303 includes a battery configured to supply power to other components of the headphone 1000, to guarantee normal operation of the headphone 1000.

As illustrated in FIG. 1, in some embodiments, the headphone 1000 further includes an ear hook 500 and a rear hook 700. The ear hook 500 is configured to be electrically connected to the battery box assembly 303 and the transducer assembly 100, and to be electrically connected to the control box assembly 301 and the transducer assembly 100. The rear hook 700 is configured to be electrically connected to the battery box assembly 303 and the control box assembly 301. When the user wears the headphone 1000, the rear hook 700 of the headphone 1000 is worn on the head, and the ear hook 500 of the headphone 1000 is worn on a back of the ear, which can improve wearing stability of the headphone 1000, ensuring that the headphone 1000 is less likely to fall off when the user is outdoors or exercising.

As illustrated in FIG. 2 to FIG. 4, the transducer assembly 100 according to the embodiments of the present disclosure includes a transducer box 10, a deformable waterproof member 30, and a button 50. The transducer box 10 has a mounting cavity 15. The transducer box 10 has a mounting area 11 in communication with the mounting cavity 10. The waterproof member 30 is located in the mounting area 11 and integrally formed with the transducer box 10 through two-color injection molding. The waterproof member 30 is configured to cover an opening of the mounting area 11, the opening facing towards an interior of the transducer box 10. The button 50 is mounted in the mounting area 11 and connected to the waterproof member 30. The button 50 is exposed from the mounting area 11 to an exterior of the transducer box 10.

As illustrated in FIG. 2, in an exemplary embodiment of the present disclosure, other components of the transducer assembly 100 are mounted in the mounting cavity 15. For example, structures such as a vibration component and a microphone of the transducer assembly 100 can be mounted in the mounting cavity 15. The waterproof member 30 and the button 50 are mounted in the mounting area 11.

As illustrated in FIG. 2 to FIG. 4, the button 50 is mounted in the mounting area 11 and at least partially exposed from the mounting area 11, to facilitate the user’s operation of the button 50. Exemplarily, the user can control the power-on and power-off of the headphone 1000 through the button 50, can also adjust the volume of the headphone 1000 through the button 50, and can also answer a call, play music, pause music, and change songs by operating the button 50. The button 50 is connected to the waterproof member 30. When the button 50 is pressed, it can drive the waterproof member 30 to deform. When the waterproof member 30 is deformed to contact the switch 90 on the circuit board 70 of the transducer component 100, the switch 90 on the circuit board 70 of the transducer component 100 can be triggered, adjusting functions of the headphone 1000.

As illustrated in FIG. 2, in some embodiments, the button 50 is in clearance fit with the mounting area 11. That is, there is a clearance between the button 50 and a side wall of the mounting area 11. When external liquid enters between the button 50 and the waterproof member 30 through a space between the button 50 and the side wall of the mounting area 11, the external liquid does not enter the mounting cavity 15 through the waterproof member 30, this is because the waterproof member 30 is integrally formed with the transducer box 10 through two-color injection molding. During movement or shaking of the headphone 1000, the liquid between the button 50 and the waterproof member 30 can flow out of the transducer assembly 100 through the clearance. Furthermore, the clearance between the button 50 and the side wall of the mounting area 11 can facilitate discharge of liquid in the mounting area 11.

As illustrated in FIG. 3 to FIG. 5, the waterproof member 30 is configured to prevent the external liquid from entering the mounting cavity 15 through the mounting area 11, preventing the external liquid from affecting the normal operation of components in the mounting cavity 15. The waterproof member 30 is connected to the side wall of the mounting area 11. A material of the waterproof member 30 of the present disclosure is different from that of the transducer box 10. When the waterproof member 30 and the transducer box 10 are integrally formed through two-color injection molding, connection between the waterproof member 30 and the transducer box 10 is relatively tight, which can effectively prevent the external liquid from entering the mounting cavity 15 through the clearance between the waterproof member 30 and the transducer box 10. Therefore, the transducer assembly 100 has better waterproof performance. In addition, connection strength between the periphery of the waterproof member 30 and the transducer box 10 is relatively high. Therefore, the periphery of the waterproof member 30 can be tightened by the transducer box 10. When the waterproof member 30 is subjected to a small external force, the waterproof member 30 is not easily deformed towards the mounting cavity 15.

Exemplarily, the headphone 1000 of the present disclosure may be a swimming headphone 1000. When the user wears the headphone 1000 while swimming or diving, the button 50 is subjected to a certain water pressure and transmits the pressure to the waterproof member 30 (usually, this pressure is less than the pressure applied by the user). Because the periphery of the waterproof member 30 is tightened by the transducer box 10, the waterproof member 30 hardly deforms when subjected to this pressure, which can prevent the button 50 from triggering the switch 90 on the circuit board 70 of the transducer assembly 100 through the waterproof member 30. In this way, the switch 90 on the circuit board 70 of the transducer assembly 100 is effectively protected against accidental triggering, guaranteeing better use experience of the user. When the user needs to adjust the functions of the headphone 1000 through the button 50, the user can apply greater pressure to the button 50. In this case, this pressure is transmitted to the waterproof member 30 through the button 50, and the waterproof member 30 can be deformed under the pressure to contact the switch 90 on the circuit board 70 of the transducer assembly 100. Therefore, the button 50 can trigger the switch 90 on the circuit board 70 of the transducer assembly 100 through the waterproof member 30, to adjust the functions of the headphone 1000.

In the transducer assembly 100 according to the embodiments of the present disclosure, the waterproof member 30 is located in the mounting area 11 and is integrally formed with the transducer box 10 through two-color injection molding. The button 50 is mounted in the mounting area 11 and connected to the waterproof member 30. When the user wears the headphone 1000 while swimming or diving and the button 50 is subjected to a certain water pressure, the button 50 transmits this pressure to the waterproof member 30. Due to high connection strength between the periphery of the waterproof member 30 and the transducer box 10, the periphery of the waterproof member 30 can be tightened by the transducer box 10. Therefore, the waterproof member 30 is not easily deformed when subjected to pressure applied by the button 50. In this way, the button 50 does not trigger the switch 90 on the circuit board 70 of the transducer assembly 100 through the waterproof member 30. In the present disclosure, the problem of accidental triggering of the switch 90 on the circuit board 70 of the transducer assembly 100 can be effectively avoided when the water pressure is high, guaranteeing better use experience of the user.

The transducer assembly 100 is further described below in conjunction with the accompanying drawings.

As illustrated in FIG. 3 to FIG. 5, in some embodiments, the mounting area 11 has a holding part 111 extending from a side wall of the transducer box 10 and defining a mounting hole 1111. The waterproof member 30 and the holding part 111 are integrally formed through two-color injection molding.

The holding part 111 is configured to support the waterproof member 30 and the button 50. When the waterproof member 30 and the holding part 111 are integrally formed through two-color injection molding, connection between the waterproof member 30 and the holding part 111 is relatively tight, and the external liquid cannot easily enter the transducer box 10 through the mounting hole 1111. In addition, connection strength between the periphery of the waterproof member 30 and the holding part 111 is relatively high, in such a manner that the periphery of the waterproof member 30 can be tightened by the holding part 111. In this way, when the user wears the headphone 1000 while swimming or diving, the waterproof member 30 can be prevented from deforming under pressure applied by the button 50, thereby avoiding accidental triggering of the switch 90 on the circuit board 70 of the transducer assembly 100.

As illustrated in FIG. 3 and FIG. 5, in some embodiments, the transducer assembly 100 further includes a circuit board 70 and a switch 90 that are accommodated in the mounting cavity 15. The switch 90 is mounted on the circuit board 70 and corresponds to the waterproof member 30. When the button 50 is pressed to drive the waterproof member 30 to deform, the waterproof member 30 abuts against the switch 90, to trigger the switch 90.

The mounting hole 1111 is in communication with the mounting cavity 15, and the mounting hole 1111 is configured to allow the switch 90 to be exposed through the mounting hole 1111. The switch 90 corresponds to the waterproof member 30. When the user needs to adjust the functions of the headphone 1000, the user presses the button 50, and the button 50 transmits pressure to the waterproof member 30, which can deform towards the interior of the transducer box 10. When the waterproof member 30 deforms, it can abut against the switch 90, triggering the switch 90 on the circuit board 70.

As illustrated in FIG. 3 to FIG. 5, in some embodiments, the waterproof member 30 has a lower hardness than the transducer box 10. In this case, it facilitates deformation of the waterproof member 30 when subjected to an external force. When the user presses the button 50, the button 50 can apply pressure to the waterproof member 30, in such a manner that the waterproof member 30 can deform to trigger the switch 90. Therefore, the user does not need to apply a large force to the button 50 to trigger the switch 90, resulting in better sensitivity of the transducer assembly 100 and better use experience of the user. When the hardness of the waterproof member 30 is greater than that of the function box, the waterproof member 30 is not easily deformed when the user triggers the button 50 and the button 50 applies pressure to the waterproof member 30, which makes it difficult to contact the switch 90, resulting in less sensitive adjustment of the transducer assembly 100 and poor use experience of the user.

As illustrated in FIG. 3 to FIG. 5, in some embodiments, the waterproof member 30 is made of soft plastic, and the transducer box 10 is made of hard plastic. When the transducer box 10 is made of hard plastic, it has high strength and is less prone to damage. In this case, the holding part 111 also has high strength. When the button 50 is pressed and applies a certain pressure to the holding part 111, the holding part 111 is not easily deformed or damaged, guaranteeing a long service life of the transducer box 10. When the waterproof member is made of soft plastic, the soft plastic can easily deform, which can facilitate the button 50 to trigger the switch 90 through the waterproof member 30. Therefore, the user can adjust the functions of the headphone 1000 without applying large pressure to the button 50, guaranteeing better use experience of the user. The soft plastic may be, but is not limited to, rubber, silica gel, thermoplastic elastomer, polyvinyl chloride, etc.

As illustrated in FIG. 3 to FIG. 5, in some embodiments, the waterproof member 30 includes a first waterproof portion 31 located in the mounting hole 1111 and a second waterproof portion 33 surrounding and connected to a periphery of the first waterproof portion 31. The second waterproof portion 33 is embedded in and connected to the holding part 111 and connected to an inner side wall of the transducer box 10. When a force from the button 50 is applied to the first waterproof portion 31, the first waterproof portion 31 is deformed under the force, and the second waterproof portion 33 remains connected to the holding part 111 and the inner side wall of the transducer box 10.

The first waterproof portion 31 is configured to deform when subjected to a pressing force applied by the button 50 (i.e., the pressing force exerted on the button 50 by the user), to allow the button 50 to trigger the switch 90 through the first waterproof portion 31. The second waterproof portion 33 is fixedly connected to both the holding part and the inner side wall of the transducer box 10. The second waterproof portion 33 is configured to keep the periphery of the waterproof member 30 tightened by the transducer box 10, to prevent accidental triggering of the switch 90 caused by deformation of the waterproof member 30 when subjected to water pressure (the button 50 is subjected to water pressure and applies the pressure to the waterproof member 30).

As illustrated in FIG. 3 and FIG. 5, a part of the second waterproof portion 33 close to the first waterproof portion 31 is embedded in and connected to the holding part 111. In this case, a part of the second waterproof portion 33 can extend into the interior of the holding part 111. The connection strength between the second waterproof portion 33 and the holding part 111 is relatively high. The second waterproof portion 33 can be tightened by the holding part 111, in such a manner that the waterproof member 30 is not easily deformed when subjected to small pressure. A part of the second waterproof portion 33 away from the first waterproof portion 31 (i.e., the periphery of the waterproof member 30) is connected to the inner side wall of the transducer box 10, which can further enhance the connection strength between the second waterproof portion 33 and the transducer box 10. Therefore, the periphery of the waterproof member 30 can be tightened by the transducer box 10, which can effectively avoid accidental triggering of the switch 90 caused by deformation of the waterproof member 30 when subjected to small pressure. In addition, when the second waterproof portion 33 is connected to both the holding part 111 and the inner side wall of the transducer box 10, the second waterproof portion 33 is less likely to become loose relative to the transducer box 10 when the first waterproof portion 31 is deformed under the pressing force applied by the user, guaranteeing stable connection between the transducer box 10 and the waterproof member 30. Furthermore, the waterproof member 30 has better waterproof performance, in such a manner that the external liquid is less likely to enter the mounting cavity 15 through the clearance between the waterproof member 30 and the transducer box 10.

As illustrated in FIG. 3, in some embodiments, the transducer box 10 has a groove 13 at the inner side wall of the transducer box 10. The second waterproof portion 33 is at least partially located in the groove 13. A concave-convex fit is formed between the second waterproof portion 33 and the inner side wall of the transducer box 10.

The transducer box 10 is provided with a protrusion surrounding the holding part 111 at the inner side wall of the transducer box 10. The groove 13 is jointly formed by the periphery of the holding part 111 facing towards a side of the mounting cavity 15 and the protrusion. The part of the second waterproof portion 33 away from the first waterproof portion 31 (i.e., the periphery of the waterproof member 30) extends into the groove 13. In this case, a connection area between the second waterproof portion 33 and the inner side wall of the transducer box 10 is large, resulting in high connection strength and tight connection between the second waterproof portion 33 and the inner side wall of the transducer box 10. Therefore, the periphery of the waterproof member 30 can be tightened by the inner side wall of the transducer box 10, in such a manner that when the waterproof member 30 is subjected to the water pressure, the first waterproof portion 31 is not easily deformed, effectively avoiding the problem of accidental triggering of the switch 90 by the waterproof member 30.

As illustrated in FIG. 3 to FIG. 5, in some embodiments, the holding part 111 includes a first protrusion 1113 and a second protrusion 1115 that are arranged in a stepped configuration in a thickness direction Z of the button 50. The first protrusion 1113 is closer to the exterior of the transducer box 10 than the second protrusion 1115.

Both the first protrusion 1113 and the second protrusion 1115 extend from the side wall of the box body. The second protrusion 1115 has a larger area than the first protrusion 1113 and is closer to a center of the mounting hole 1111 than the first protrusion 1113. The first waterproof portion 31 is at least partially supported on the second protrusion 1115 and connected to the first protrusion 1113. The second waterproof portion 33 is connected to the side of the second protrusion 1115, the side facing towards the mounting cavity 15. When the second protrusion 1115 and the first protrusion 1113 are arranged in the stepped configuration, the contact area between the holding part 111 and the waterproof member 30 is large. After the holding part 111 and the waterproof member 30 are integrally formed through two-color injection molding, the connection strength between the holding part 111 and the waterproof member 30 is high, and the waterproof member 30 is less likely to become loose relative to the holding part 111.

As illustrated in FIG. 4 and FIG. 5, in some embodiments, the second protrusion 1115 has an injection hole 11151 penetrating the second protrusion 1115. The second waterproof portion 33 is at least partially located in the injection hole 11151 to be embedded in and connected to the second protrusion 1115.

During the integral two-shot injection molding process of the holding part 111 and the waterproof member 30, molten soft plastic flows into the injection hole 11151 and solidifies to form the waterproof member 30. In this case, the second waterproof portion 33 of the waterproof member 30 can form a tight embedded connection with the holding part 111. The periphery of the waterproof member 30 can be tightened by the holding part 111, in such a manner that the waterproof member 30 is not easily deformed when subjected to the water pressure, and the external liquid is less likely to enter the mounting cavity 15 through the mounting hole 1111, resulting in better waterproof performance of the transducer assembly 100. The number of injection holes 11151 may be, but is not limited to, one, two, three, four, or more. When a plurality of injection holes 11151 are provided, the connection strength between the second waterproof portion 33 and the holding part 111 is higher. In the present disclosure, four injection holes 11151 are provided and uniformly distributed on the second waterproof portion 33.

As illustrated in FIG. 3 and FIG. 5, in some embodiments, the first protrusion 1113 is provided with a lug 11131 at a periphery of the first protrusion 1113, the periphery facing towards the second protrusion 1115. The first waterproof portion 31 is formed with a recess 311 at an outer side of the first waterproof portion 31. The recess 311 is engaged with the lug 11131. In this case, a connection area between the first waterproof portion 31 and the first protrusion 1113 is larger, the connection strength between the first waterproof portion 31 and the first protrusion 1113 is higher, and the periphery of the first waterproof portion 31 can be tightened by the first protrusion 1113. Therefore, when the waterproof member 30 is subjected to water pressure, the first waterproof portion 31 is not easily deformed, which can effectively avoid accidental triggering of the switch 90 caused by deformation of the waterproof member 30. The number of lugs 11131 may be, but is not limited to, one, two, three, four, or more, and the number of recesses 311 is the same as the number of lugs 11131. When a plurality of lugs 11131 are provided, the connection strength between the first waterproof portion 31 and the holding part 111 is high. In the present disclosure, four lugs 11131 are provided.

As illustrated in FIG. 5 and FIG. 6, in some embodiments, the holding part 111 has a supporting portion 113 at a side of the holding part 111, the side facing towards the mounting cavity 15. The supporting portion 113 is disposed to surround the mounting hole 1111 and protrudes towards the mounting cavity 15 relative to the second protrusion 1115.

The supporting portion 113 is configured to enhance the strength of the holding part 111. During the integral two-color injection molding process of the waterproof member 30 and the supporting portion 113, the supporting portion 113 can provide good support for the holding part 111, which can effectively prevent the holding part 111 from deforming under pressure during processing, making the holding part 111 less likely to be damaged. When the supporting portion 113 is disposed at the side of the holding part 111, the side facing towards the interior of the transducer box 10, the strength of the holding part 111 can be enhanced while maintaining an overall structure of the product. In addition, the supporting portion 113 can also be embedded in and connected to the second waterproof portion 33. When the first waterproof portion 31 is subjected to the water pressure, the supporting portion 113 can tighten and fix the second waterproof portion 33, which can avoid accidental triggering of the switch 90 caused by deformation of the first waterproof portion 31.

The number of supporting portions 113 may be, but is not limited to, one, two, three, four, or more. When one supporting portion 113 is provided, a structure of the holding part 111 is relatively simple and processing is relatively convenient. When a plurality of supporting portions 113 are provided, the holding part 111 has higher strength and is less likely to deform. In this case, the plurality of supporting portions 113 can be evenly or unevenly distributed on the holding part 111. In the present disclosure, four supporting portions 113 are provided, and the four supporting portions 113 and the four injection holes 11151 are arranged at intervals from each other.

As illustrated in FIG. 3 to FIG. 5, in some embodiments, in a thickness direction Z of the waterproof member 30, the first waterproof portion 31 has a first side 313 and a second side 315 that are opposite to each other. The first side 313 of the first waterproof portion is closer to the exterior of the transducer box 10 than the second side of the first waterproof portion. The first side 313 of the first waterproof portion includes a mounting post 3131 having an insertion hole 3132. In the thickness direction Z of the waterproof member 30, the button 50 has a first side 51 and a second side 53 that are opposite to each other. The first side 51 of the button is closer to the exterior of the transducer box 10 than the second side 53 of the button. The second side 53 of the button includes a connection post 531 that extends into the insertion hole 3132 of the mounting post 3131.

When the connection post 531 extends into the insertion hole 3132, the connection between the button 50 and the waterproof member 30 is relatively stable, and the button 50 is less likely to become loose relative to the waterproof member 30. The connection post 531 can at least partially correspond to the switch 90, in such a manner that when the button 50 is pressed, the connection post 531 can at least partially drive the waterproof member 30 to deform and trigger the switch 90 through the waterproof member 30, facilitating the adjustment of the functions of the headphone 1000.

As illustrated in FIG. 3, in some embodiments, the first waterproof portion has a triggering protrusion 3151 at a second side 315 of the first waterproof portion. The triggering protrusion 3151 corresponds to the switch 90 in a thickness direction Z of the waterproof member 30. The triggering protrusion 3151 is configured to abut against the switch 90.

The triggering protrusion 3151 protrudes from the second side 315 of the first waterproof portion towards the mounting cavity 15. When the user applies the external force to the button 50, the button 50 drives the first waterproof portion 31 to deform. In this case, the triggering protrusion 3151 can abut against the switch 90, triggering the switch 90. When the triggering protrusion 3151 is disposed at the second side 315 of the first waterproof portion, the waterproof member 30 can trigger the switch 90 more easily, resulting in better sensitivity of the transducer assembly 100 and better use experience of the user.

As illustrated in FIG. 4 and FIG. 5, in some embodiments, a center of the insertion hole 3132 is located on a length mid-plane and a width mid-plane of the first waterproof portion 31.

In this case, the insertion hole 3132 is centered on the waterproof member 30, and the connection post 531 on the button 50 is also centered. When the button 50 is subjected to the external force, the force is more concentrated on the middle part of the button 50, in such a manner that deformation of the first waterproof portion 31 is also more concentrated on the middle part. In this way, on the one hand, the connection post 531 on the button 50 can better trigger the switch 90 through the first waterproof portion 31. On the other hand, a pulling force applied to the periphery of the waterproof member 30 (i.e., the second waterproof portion 33) is relatively uniform, which can avoid a problem that some positions are subjected to a greater pulling force than other parts, leading to easy damage of the second waterproof portion 33. When the second waterproof portion 33 is uniformly stressed at all positions, a service life of the waterproof member 30 can be prolonged.

As illustrated in FIG. 3 to FIG. 5, in some embodiments, a plurality of mounting posts 3131 are provided, and each of the plurality of mounting posts 3131 has the insertion hole 3132. A plurality of connection posts 531 are provided and inserted in a plurality of insertion holes 3132, respectively. In this case, a plurality of joints are formed between the button 50 and the first waterproof portion 31, in such a manner that the connection strength between the button 50 and the waterproof member 30 is higher, and the connection stability between the button 50 and the waterproof member 30 is better, which can further avoid the problem of the button 50 becoming loose relative to the waterproof member 30.

As illustrated in FIG. 4 and FIG. 5, in some embodiments, the plurality of mounting posts 3131 are arranged in sequence in a length direction X or a width direction Y of the waterproof member 30. Adjacent mounting posts 3131 of the plurality of mounting posts 3131 share a side wall. The side wall of at least one of the plurality of mounting post 3131 has a notch 3133 extending through an inner side and an outer side of the side wall and in communication with the insertion hole 3132.

When the connection post 531 is inserted in the insertion hole 3132, the notch 3133 is configured to discharge gas inside the insertion hole 3132, to allow the connection post 531 to be inserted in a bottom of the insertion hole 3132. Therefore, the connection stability between the connection post 531 and the insertion hole 3132 is better, and the connection stability between the button 50 and the waterproof member 30 is better.

As illustrated in FIG. 4 and 5, in some embodiments, each of the plurality of mounting posts 3131 has a notch 3133. An extension direction of a plurality of notches 3133 is consistent with the length direction X or the width direction Y of the waterproof member 30.

In an embodiment, the plurality of mounting posts 3131 are arranged in sequence in the length direction X of the waterproof member 30, and the extension direction of the plurality of notches 3133 is consistent with the length direction X of the waterproof member 30. In this case, the plurality of notches 3133 can be in communication with one another and arranged substantially along a straight line. During a process of inserting the connection post 531 into the insertion hole 3132, air in each of the plurality of insertion holes 3132 enters the notch 3133 formed by the mounting post 3131. The air in the notch 3133 can flow through the other notches 3133 and ultimately be discharged out of the waterproof member 30.

In another embodiment, the plurality of mounting posts 3131 are arranged in sequence in the width direction Y of the waterproof member 30, and the extension direction of the plurality of notches 3133 is consistent with the width direction Y of the waterproof member 30. In this case, the plurality of notches 3133 can be in communication with one another and arranged substantially along a straight line. During the process of inserting the connection post 531 into the insertion hole 3132, air in each of the plurality of insertion holes 3132 enters the notch 3133 formed by the connection post 3131. The air in the notch 3133 can flow through the other notches 3133 and be discharged out of the waterproof member 30.

Each of the plurality of mounting posts 3131 has the notch 3133. When the extension direction of the plurality of notches 3133 is consistent with the length direction X or the width direction Y of the waterproof member 30, air in the plurality of insertion holes 3132 can be easily discharged out of the waterproof member 30. Therefore, the connection between the connection post 531 and the insertion hole 3132 is relatively stable, and the connection strength between the button 50 and the waterproof member 30 is relatively high.

As illustrated in FIG. 7, the headphone system 10000 according to the embodiments of the present disclosure includes the headphone 1000 according to the above-described embodiments and a charging case 3000 configured to charge the headphone 1000. The charging case 3000 includes a charging compartment. When the headphone 1000 needs to be charged, a battery case of the headphone 1000 can be accommodated in the charging compartment, and the charging case 3000 can charge the battery inside the battery case.

In the headphone system 10000 according to the embodiments of the present disclosure, the waterproof member 30 is located in the mounting area 11 and integrally formed with the transducer box 10 through two-color injection molding. The button 50 is mounted in the mounting area 11 and connected to the waterproof member 30. When the user wears the headphone 1000 while swimming or diving, and the button 50 is subjected to a certain water pressure, the button 50 transmits the pressure to the waterproof member 30. Since the connection strength between the periphery of the waterproof member 30 and the transducer box 10 is relatively high, the periphery of the waterproof member 30 can be tightened by the transducer box 10. Therefore, the waterproof member 30 is not easily deformed when subjected to the pressure applied by the button 50, in such a manner that the button 50 does not trigger the switch 90 on the circuit board 70 of the transducer assembly 100 through the waterproof member 30. In the present disclosure, a problem of accidental triggering of the switch 90 on the circuit board 70 of the transducer assembly 100 can be effectively avoided when the water pressure is high, ensuring better use experience of the user.

In the transducer assembly, headphone, and headphone system according to the embodiments of the present disclosure, the waterproof member is located in the mounting area and is integrally formed with the transducer box through two-color injection molding. The button is mounted in the mounting area and connected to the waterproof member. When a user wears the headphone while swimming or diving, and the button is subjected to a certain water pressure, the button transfers the pressure to the waterproof member. Since connection strength between the periphery of the waterproof member and the transducer box is relatively high, the periphery of the waterproof member can be tightened by the transducer box. Therefore, the waterproof member is not easily deformed when subjected to the pressure applied by the button, in such a manner that the button does not trigger the switch on the circuit board of the transducer assembly through the waterproof member. In the present disclosure, a problem of accidental triggering of the switch on the circuit board of the transducer assembly can be effectively avoided when the water pressure is high, ensuring better use experience of the user.

Any combination of technical features in the above-described embodiments may be adopted. To make the description simple, all possible combinations of the technical features in the above-described embodiments are not described. However, as long as there is no contradiction in the combination of the technical features in the embodiments, all such combinations should be considered in the scope of this specification. In addition, other implementations may be derived from the above-described embodiments, such that structural and logical substitutions and changes may be made without departing from the scope of the present disclosure.

The above embodiments illustrate merely some implementations of the present disclosure, which are described in details but are not construed to limit the scope of the present disclosure. It should be pointed that, for those skilled in the art, without departing from the principle of the present disclosure, various changes and improvements may be made, which are covered by the protection scope of the present disclosure. Therefore, the protection scope of the present disclosure should be determined by the appended claims.

What is claimed is:

1. A transducer assembly, comprising:
a transducer box having a mounting cavity, wherein the transducer box has a mounting area in communication with the mounting cavity;
a deformable waterproof member located in the mounting area and integrally formed with the transducer box through two-color injection molding, wherein the waterproof member is configured to cover an opening of the mounting area, the opening facing towards an interior of the transducer box; and
a button mounted in the mounting area and connected to the waterproof member, wherein the button is exposed from the mounting area to an exterior of the transducer box.

2. The transducer assembly according to claim 1, wherein the mounting area has a holding part extending from a side wall of the transducer box and defining a mounting hole, the waterproof member and the holding part being integrally formed through two-color injection molding.

3. The transducer assembly according to claim 1, wherein the waterproof member has a lower hardness than the transducer box.

4. The transducer assembly according to claim 3, wherein:
the waterproof member is made of soft plastic; and
the transducer box is made of hard plastic.

5. The transducer assembly according to claim 2, wherein the waterproof member comprises a first waterproof portion located in the mounting hole and a second waterproof portion surrounding and connected to a periphery of the first waterproof portion, wherein:
the second waterproof portion is embedded in and connected to the holding part and connected to an inner side wall of the transducer box; and
when a force from the button is applied to the first waterproof portion, the first waterproof portion is deformed under the force, and the second waterproof portion remains connected to the holding part and the inner side wall of the transducer box.

6. The transducer assembly according to claim 5, wherein the holding part comprises a first protrusion and a second protrusion that are arranged in a stepped configuration in a thickness direction of the button, the first protrusion being closer to the exterior of the transducer box than the second protrusion.

7. The transducer assembly according to claim 6, wherein the second protrusion has an injection hole penetrating the second protrusion, the second waterproof portion being at least partially located in the injection hole to be embedded in and connected to the second protrusion.

8. The transducer assembly according to claim 6, wherein the holding part has a supporting portion at a side of the holding part, the side facing towards the transducer box, the supporting portion being disposed to surround the mounting hole and protruding towards the interior of the transducer box relative to the second protrusion.

9. The transducer assembly according to claim 6, wherein:
the first protrusion is provided with a lug at a periphery of the first protrusion, the periphery facing towards the second protrusion; and
the first waterproof portion is formed with a recess at an outer side of the first waterproof portion, the recess being engaged with the lug.

10. The transducer assembly according to claim 5, wherein the transducer box has a groove at the inner side wall of the transducer box, the second waterproof portion being at least partially located in the groove, and a concave-convex fit being formed between the second waterproof portion and the inner side wall of the transducer box.

11. The transducer assembly according to claim 5, wherein:
in a thickness direction of the waterproof member, the first waterproof portion has a first side and a second side that are opposite to each other, the first side of the first waterproof portion being closer to the exterior of the transducer box than the second side of the first waterproof portion, the first side of the first waterproof portion comprising a mounting post having an insertion hole; and
in the thickness direction of the waterproof member, the button has a first side and a second side that are opposite to each other, the first side of the button being closer to the exterior of the transducer box than the second side of the button, the second side of the button comprising a connection post that extends into the insertion hole of the mounting post.

12. The transducer assembly according to claim 11, wherein a center of the insertion hole is located on a length mid-plane and a width mid-plane of the first waterproof portion.

13. The transducer assembly according to claim 11, wherein:
a plurality of mounting posts are provided, each of the plurality of mounting posts having the insertion hole; and
a plurality of connection posts are provided and inserted in a plurality of insertion holes, respectively.

14. The transducer assembly according to claim 13, wherein the plurality of mounting posts are arranged in sequence in a length direction or a width direction of the waterproof member, adjacent mounting posts of the plurality of mounting posts sharing a side wall, and the side wall of at least one of the plurality of mounting posts having a notch extending through an inner side and an outer side of the side wall and in communication with the insertion hole.

15. The transducer assembly according to claim 14, wherein each of the plurality of mounting posts has the notch, an extension direction of a plurality of notches being consistent with the length direction or the width direction of the waterproof member.

16. The transducer assembly according to claim 1, wherein the button is in clearance fit with the mounting area.

17. The transducer assembly according to claim 1, further comprising a circuit board and a switch that are accommodated in the transducer box, wherein:
the switch is mounted on the circuit board and corresponds to the waterproof member; and
when the button is pressed to drive the waterproof member to deform, the waterproof member abuts against the switch to trigger the switch.

18. The transducer assembly according to claim 17, wherein the first waterproof portion of the waterproof member has a triggering protrusion at a second side of the first waterproof portion, the triggering protrusion corresponding to the switch in a thickness direction of the waterproof member, and the triggering protrusion being configured to abut against the switch.

19. A headphone, comprising the transducer assembly according to claim 1.

20. A headphone system, comprising:
the headphone according to claim 19; and
a charging case configured to charge the headphone.
